(19) United States
(12) Patent Application Publication
(10) Pub. No.: US 2022/0276710 A1
(43) Pub. Date: Sep. 1, 2022

(54) GENERATION DEVICE, GENERATION METHOD, PROGRAM, AND TACTILE-SENSE PRESENTATION DEVICE

(71) Applicant: SONY GROUP CORPORATION, TOKYO (JP)

(72) Inventors: RYO YOKOYAMA, TOKYO (JP); OSAMU ITO, TOKYO (JP); IKUO YAMANO, TOKYO (JP); MASAKO KADOBAYASHI, TOKYO (JP)

(21) Appl. No.: 17/631,547

(22) PCT Filed: Jul. 20, 2020
(86) PCT No.: PCT/JP2020/028178

§ 371 Date: Jan. 31, 2022

(30) Foreign Application Priority Data
Aug. 7, 2019 (JP) 2019-145674

(51) Int. Cl. G06F 3/01; G10H 1/00; G06F 1/16

(52) U.S. Cl. CPC G06F 3/016; G10H 1/0016; G06F 1/163; G10H 2220/015; G10H 2220/021

(57) ABSTRACT

Included are: an acquisition unit (13b) configured to acquire identification information and a time-series feature regarding a signal indicating a tactile sensation, the identification information and the time-series feature being visually expressed; and a generation unit (13c) configured to generate a control signal for a tactile-sense presentation device (100) on the basis of the above identification information and the above time-series feature acquired by the acquisition unit (13b).

### FIELD

The present disclosure relates to a generation device, a generation method, a program, and a tactile-sense presentation device.

### BACKGROUND

There have been proposed various techniques using so-called haptics in which a tactile stimulation with force, vibration, motion, or the like is presented to a user to cause the user to perceive, for example, the tactile sensation to an object or the like that is not actually present.

For example, Patent Literature 1 discloses a technique for causing a user to perceive a predetermined tactile sensation through a game controller that is a tactile-sense presentation device in a case where a predetermined event such as explosion occurs in a virtual reality space such as a game.

### CITATION LIST

### Patent Literature

Patent Literature 1: JP 2015-166890 A

### SUMMARY

### Technical Problem

However, disadvantageously, a tactile sensation perceived by a person is difficult to share in a manner different from any manners based on actual physical experience.

For example, a tactile-sense presentation device presents a tactile stimulation with vibration or the like due to driving of an actuator installed in the device. In this case, the tactile stimulation to be presented, namely, the tactile sensation to be expressed can be visually expressed only by the waveform of a control signal for controlling the actuator. This also indicates that the tactile sensation to be expressed can be designed only by creation of the control signal.

For this reason, for example, in making of content including tactile-sense presentation, sharing a tactile sensation to be expressed in the content is difficult, so that it is difficult to distinguish between a person who considers the tactile sensation and a person who actually creates the above control signal.

Therefore, the present disclosure proposes a novel and improved generation device, generation method, program, and tactile-sense presentation device that enable generation of a control signal for tactile-sense presentation while sharing a tactile sensation to be expressed in a manner different from any manners based on actually physical experience.

### Solution to Problem

According to the present disclosure, a generation device is provided. The generation device includes an acquisition unit and a generation unit. The acquisition unit is configured to acquire identification information and a time-series feature regarding a signal indicating a tactile sensation, the identification information and the time-series feature being visually expressed. The generation unit is configured to generate a control signal for a tactile-sense presentation device, on a basis of the identification information and the time-series feature acquired by the acquisition unit.

According to the present disclosure, a generation method executed by a computer is provided. The generation method includes acquiring and generating. Acquiring acquires identification information and a time-series feature regarding a signal indicating a tactile sensation, the identification information and the time-series feature being visually expressed. Generating generates a control signal for a tactile-sense presentation device, on a basis of the identification information and the time-series feature acquired by the acquiring.

According to the present disclosure, a program for causing a computer to execute is provided. The program executes an acquisition procedure and a generation procedure. The acquisition procedure acquires identification information and a time-series feature regarding a signal indicating a tactile sensation, the identification information and the time-series feature being visually expressed. The generation procedure generates a control signal for a tactile-sense presentation device, on a basis of the identification information and the time-series feature acquired by the acquisition procedure.

According to the present disclosure, a tactile-sense presentation device is provided. The tactile-sense presentation device includes a vibration unit and a control unit. The control unit is configured to acquire identification information and a time-series feature regarding a signal indicating a tactile sensation that are visually expressed, to generate a control signal for vibrating the vibration unit, on a basis of the identification information and the time-series feature that are acquired.

### BRIEF DESCRIPTION OF DRAWINGS

FIG. 1A is a schematically explanatory illustration (part 1) of a generation system according to an embodiment.

FIG. 1B is a schematically explanatory illustration (part 2) of the generation system according to the embodiment.

FIG. 1C is a schematically explanatory illustration (part 3) of the generation system according to the embodiment.

FIG. 1D is a schematically explanatory illustration (part 4) of the generation system according to the embodiment.

FIG. 1E is a schematically explanatory illustration (part 5) of the generation system according to the embodiment.

FIG. 2 is a block diagram illustrating an exemplary configuration of the generation system according to the embodiment.

FIG. 3A explanatorily illustrates parameters according to the embodiment.

FIG. 3B illustrates an exemplary first design.

FIG. 3C illustrates an exemplary second design.

FIG. 3D illustrates another exemplary design (part 1).

FIG. 3E illustrates yet another exemplary design (part 2).

FIG. 4A illustrates a first modification.

FIG. 4B illustrates a second modification.

FIG. 4C illustrates a third modification.

FIG. 5 is a flowchart illustrating a processing procedure executed by a generation device according to the embodiment.

FIG. 6 is a hardware configuration diagram illustrating an example of a computer that achieves functions of the generation device.

### DESCRIPTION OF EMBODIMENTS

A preferred embodiment of the present disclosure will be described in detail below with reference to the accompanying drawings. Note that in the present specification and the drawings, the same reference signs are given to constituent elements each having substantially the same functional configuration and the redundant description will be omitted.

The description will be given in the following order.

1. Overview of Generation Method according to embodiment

2. Configuration of Generation System according to embodiment

3. Exemplary Designs in Tactile Sensation according to embodiment

3-1. Exemplary First Design

3-2. Exemplary Second Design

3-3. Other Exemplary Designs

4. Exemplary Designs in Tactile Sensation according to Modifications

4-1. First Modification

4-2. Second Modification

4-3. Third Modification

5. Processing Procedure of Generation System according to embodiment

6. Hardware Configuration

7. Conclusion

### 1. OVERVIEW OF GENERATION METHOD ACCORDING TO EMBODIMENT

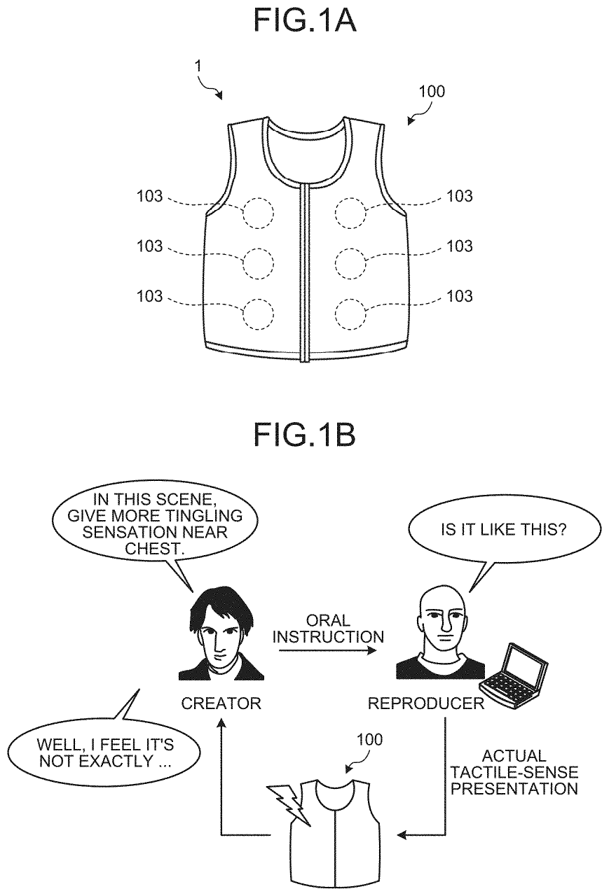

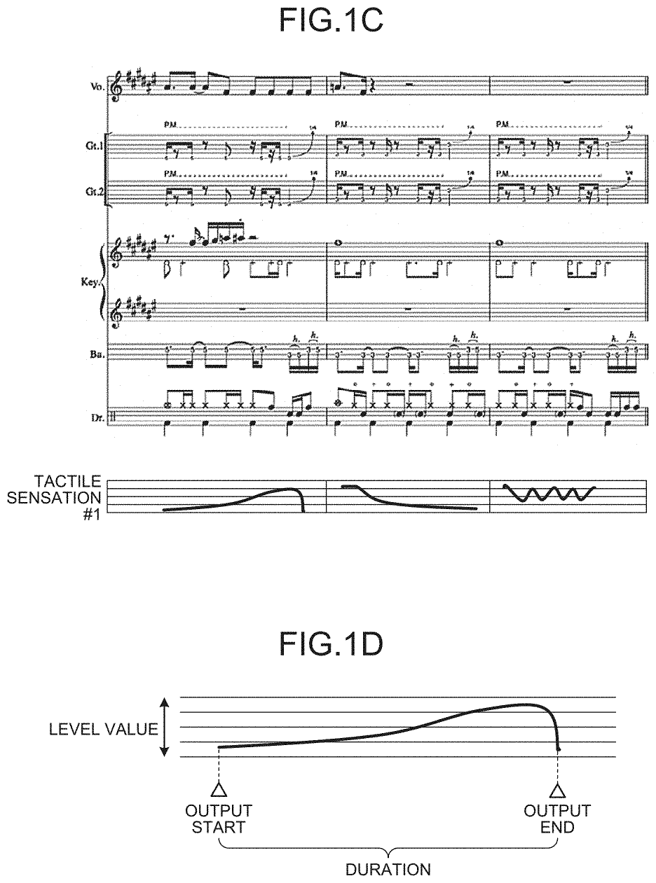

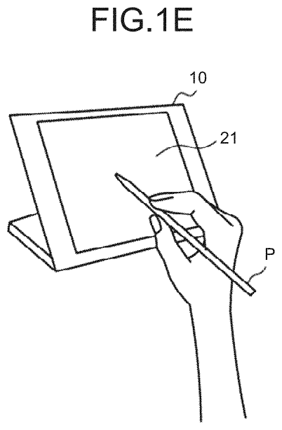

First, the overview of a generation method according to an embodiment will be described with reference to FIGS. 1A to 1E. FIGS. 1A to 1E are schematically explanatory illustrations (part 1) to (part 5) of the generation method according to the embodiment.

As illustrated in FIG. 1A, a generation system 1 according to the embodiment includes a tactile-sense presentation device 100. The tactile-sense presentation device 100 is a device that presents a tactile stimulation to the user, and includes, for example, a plurality of vibration units 103 inside itself.

Each vibration unit 103 is, for example, an actuator. Each vibration unit 103 drives due to a control signal generated by a generation device 10 described below to generate vibration, and presents the vibration as a tactile stimulation. As the actuator, for example, an eccentric motor, a linear vibrator, a piezoelectric element, or the like can be provided.

Note that FIG. 1A illustrates a case where the tactile-sense presentation device 100 includes six vibration units 103; however, this is merely an example, and thus the number of vibration units 103 is not limited.

In addition, FIG. 1A illustrates a case where the tactile-sense presentation device 100 is a sleeveless best type; however, it is a matter of course that the tactile-sense presentation device 100 may be a sleeved wear type. In a case of the sleeved wear type, one or more vibration units 103 can be disposed not only at the chest and abdomen of the user but also at positions corresponding to both arms of the user.

In a case where the tactile-sense presentation device 100 is provided as a wearable type, the tactile-sense presentation device 100 is not limited to such an outerwear as illustrated in FIG. 1A, and may be provided as trousers, socks, shoes, a belt, a hat, gloves, glasses, a mask, or the like.

The tactile-sense presentation device 100 is not limited to a wearable type, and thus may be an on-hand type mounted on a device held with a hand of the user, for example, a game controller, a smartphone, a portable music player, or the like.

The tactile-sense presentation device 100 is not limited to a wearable type or an on-hand type, and thus may be a slate or floor type installed in furniture such as a bed or a chair or various facilities.

Meanwhile, disadvantageously, a tactile sensation perceived by a person is difficult to share in a manner different from any manners based on actually physical experience. For example, a tactile stimulation to be presented to a user, namely, a tactile sensation to be expressed to the user can be visually expressed only by the waveform of a control signal for vibrating such vibration units 103 described above. This also indicates that the maker of content including tactile-sense presentation can design a tactile sensation to be expressed only by creating such a control signal.

For this reason, in making of the above content, a situation may arise that it is difficult to distinguish between a person who considers the tactile sensation to be expressed in the content and a person who actually creates the above control signal.

Here, assumed is a case of intentional distinguishment between a person who considers a tactile sensation as a “creator” and a person who creates a control signal as a “reproducer”. The “creator” corresponds to, for example, a director, a producer, or the like in making of content. The “reproducer” corresponds to, for example, a member of technical staff or the like.

In such a case, as described above, the tactile sensation considered by the creator can be visually expressed only by the waveform of the control signal for vibrating the above vibration units 103. Thus, as illustrated in FIG. 1B, the creator verbally instructs the reproducer to express the tactile sensation to be expressed, for example.

In response to this instruction, the reproducer creates the control signal for the tactile-sense presentation device 100 on the basis of the detail of the instruction, and the tactile-sense presentation device 100 is driven to actually present the tactile sensation. Then, the creator needs, for example, to physically experience the tactile-sense presentation by the creator's self. If the tactile-sense presentation matches the tactile sensation that the creator himself or herself desires to express, the creator needs to give OK. Otherwise, if the tactile-sense presentation does not match the tactile sensation, the creator needs to cause the reproducer to perform trial and error until the tactile-sense presentation matches the tactile sensation.

Thus, in the situation where the creator and the reproducer are distinguished, in a case where the creator can share, with the reproducer, only tactilely the tactile sensation that the creator desires to express, it is difficult to convey the intention of the creator to the reproducer. Consequently, it takes cumbersome tasks, for example, to make video content.

Note that this similarly applies to a case where the content is, for example, audio content including tactile-sense presentation and it is desired to distinguish between a “creator” who is the preparer of the tactile-sense presentation part in the audio content and a “reproducer” who is the manipulator of the tactile-sense presentation device 100 that demonstrates the tactile-sense presentation part.

In such a case, for example, even though it attempts to release the audio content in a live venue or the like, if the creator can share only tactilely after all, with the reproducer, the tactile sensation that the creator desires to express, it takes cumbersome tasks from the preparation stage for the demonstration of the tactile-sense presentation part.

Therefore, in the generation method according to the embodiment, identification information and a time-series feature regarding a signal indicating a tactile sensation that are visually expressed are acquired, and a control signal for the tactile-sense presentation device 100 is generated on the basis of the identification information and the time-series feature that are acquired.

Specifically, consider a case where the content is audio content including tactile-sense presentation. As described above, it is assumed that the “creator” and the “reproducer” of the tactile-sense presentation part are distinguished.

In such a case, as illustrated in FIG. 1C, in the generation method according to the embodiment, the tactile sensation to be expressed is visually expressed, for example, on a five-line staff score similarly to other music parts. The expression includes at least the identification information and time-series feature of the tactile sensation. The time-series feature mentioned here indicates, for example, a temporal transition.

For example, a “tactile sensation #1” in the figure indicates identification information of a preset tactile sensation. In addition, a curve drawn on the five-line staff score of the “tactile sensation #1” part indicates a temporal transition. Hereinafter, visual expression of the tactile sensation notated as describe above may be referred to as “tactile score”.

The tactile score is a notation on a five-line staff score, and thus time is represented horizontally and is drawn from left to right similarly to a case of music. Therefore, as illustrated in FIG. 1D, the start point at the left end represents the position of “output start”, and the end point at the right end represents the position of “output end”. The portion between the start point and the end point represents the “duration”.

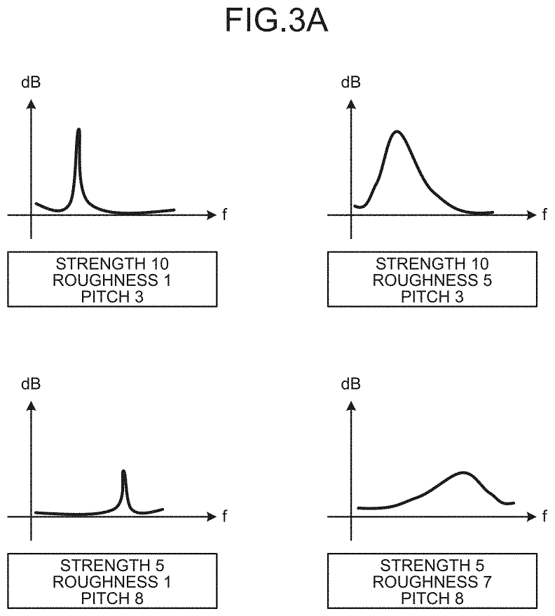

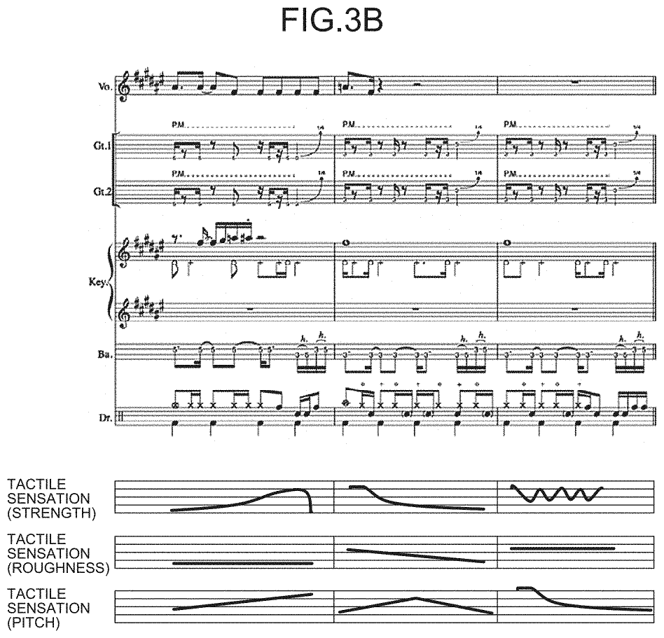

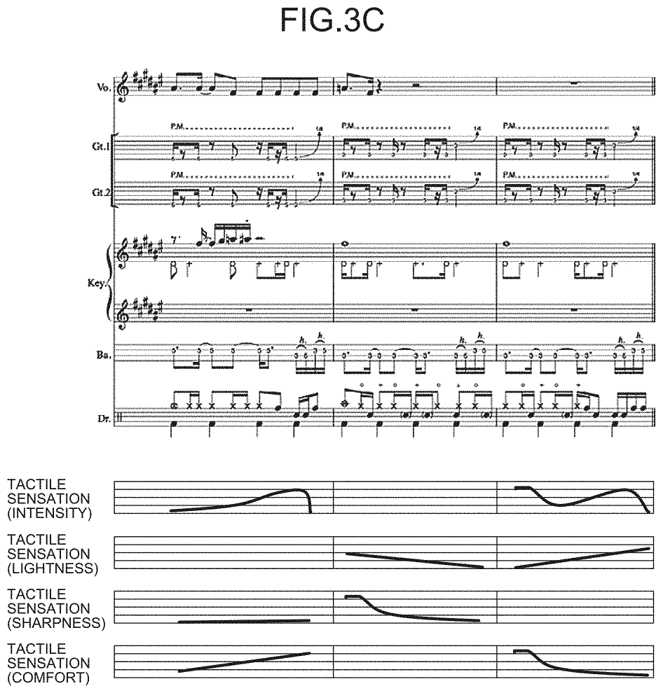

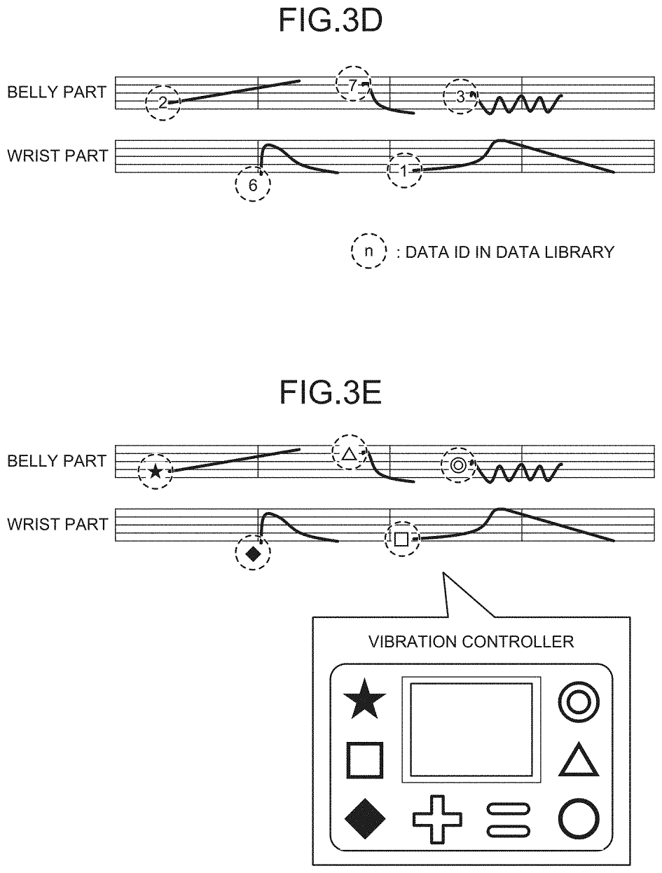

Further, in the tactile score, a level value is represented vertically, similarly to pitch in the case of music. Note that the tactile score does not directly represent the waveform of a control signal for the tactile-sense presentation device 100; however, the tactile score represents identification information and a temporal transition of a parameter resulting from parameterization of a feature that the control signal has as data indicating a tactile sensation. The above level value thus indicates the level value of the parameter. Specific examples of such parameters will be described below with reference to FIGS. 3A to 3E.

As illustrated in FIG. 1E, for example, such a tactile score can be input from a touch panel 21 included in the generation device 10 while using a pointing device such as an electronic pen P or a finger. Therefore, for example, in a case where the composer of the musical composition of the audio content is a “creator” who also serves as the preparer of a tactile-sensation presentation part, the creator can create the musical score and the tactile score in parallel through the touch panel 21.

Furthermore, the reproducer can generate a control signal for the tactile-sense presentation device 100 on the basis of the tactile score created by the creator and visually expressing the tactile sensation that the creator desires to express in accordance with the musical composition, and can manipulate the tactile-sense presentation device 100 in accordance with the creator's intention.

Note that the composer of the musical composition of the audio content is not necessarily the creator who is the preparer of the tactile-sensation presentation part. In such a case, the creator can design the tactile sensation to be expressed by adding the tactile-sensation presentation part to the musical score of the composer while referring thereto, for example.

Here, the case where the reproducer generates the control signal for the tactile-sense presentation device 100 on the basis of the tactile score and manipulates the tactile-sense presentation device 100 has been described as an example. However, the control signal for the tactile-sense presentation device 100 may be automatically generated on the basis of the tactile score without depending on the reproducer, and the tactile-sense presentation device 100 may be manipulated automatically.

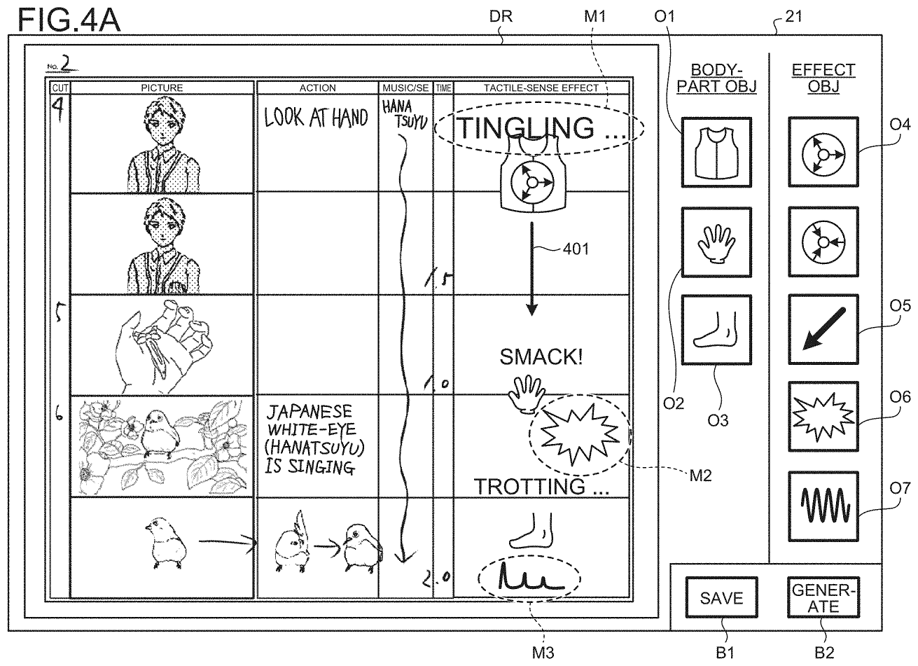

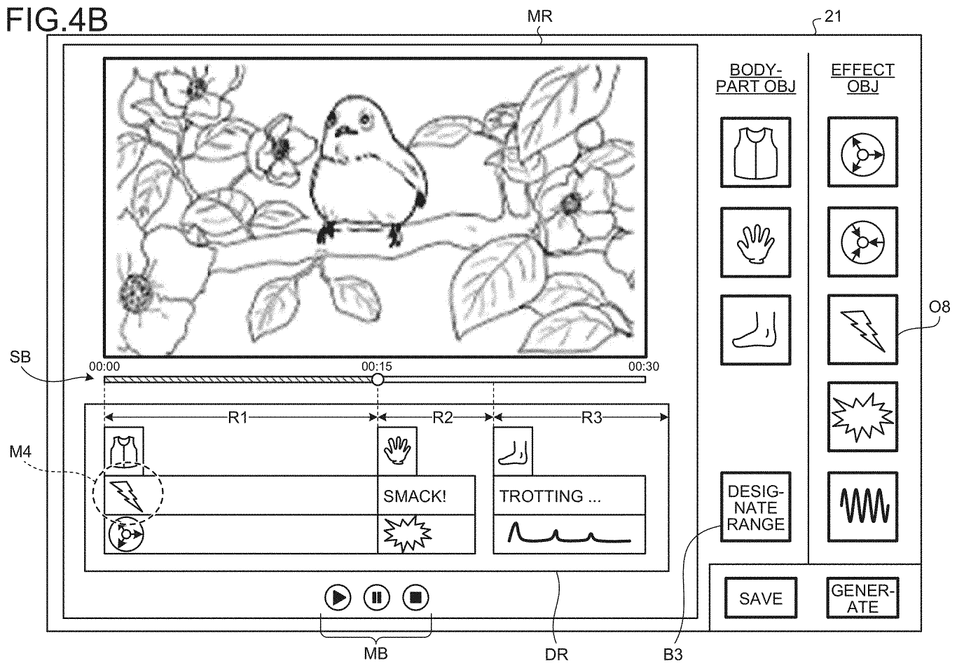

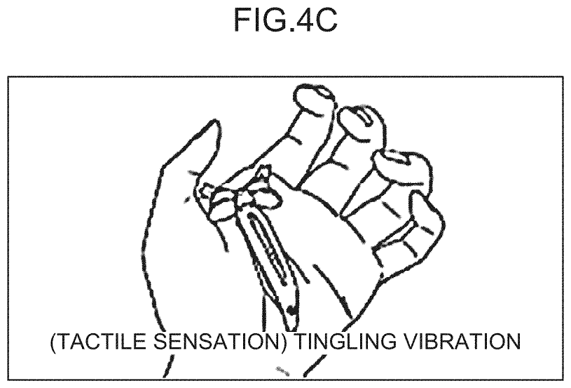

Furthermore, here, the case where the content is the audio content including the tactile-sense presentation has been described as an example; however, the content may be video content. An exemplary design in tactile sensation in such a case will be described below with reference to FIGS. 4A and 4B.

In the design in tactile sensation, a visual and intuitive design through a graphical user interface (GUI) can be performed. Such a case will also be described below with reference to FIGS. 4A and 4B.

Hereinafter, a Configuration Example of the generation system 1 to which the generation method according to the above embodiment is applied will be described more specifically.

### 2. CONFIGURATION OF GENERATION SYSTEM ACCORDING TO EMBODIMENT

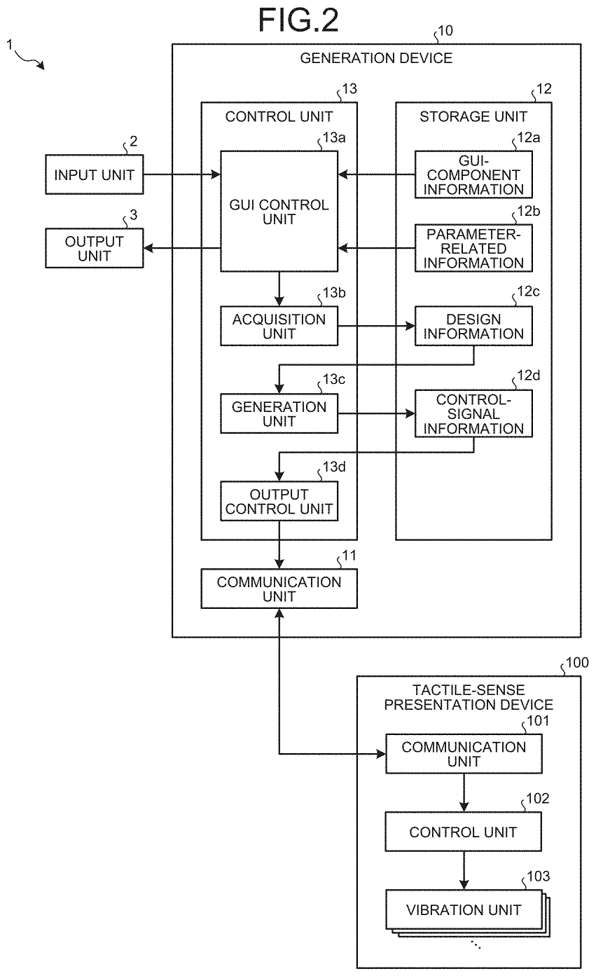

FIG. 2 is a block diagram illustrating a Configuration Example of the generation system 1 according to the embodiment. Note that in FIG. 2, only constituent elements necessary for describing the features of the embodiment are illustrated, and thus description of the general components are omitted.

That is to say, each constituent element illustrated in FIG. 2 is functionally conceptual, and thus is not necessarily configured physically as illustrated. For example, the specific mode of separation or integration of each block is not limited to that illustrated in the figure, and thus the entirety or part of each block may be functionally or physically separated or integrated on a unit basis in accordance with various types of loads or usage situations.

In addition, in the description with reference to FIG. 2, description of the constituent elements already given may be simplified or omitted.

As illustrated in FIG. 2, the generation system 1 according to the embodiment includes the generation device 10 and the tactile-sense presentation device 100. The generation device 10 and the tactile-sense presentation device 100 are provided mutually communicable through wired communication or wireless communication.

The generation device 10 includes an input unit 2, an output unit 3, a communication unit 11, a storage unit 12, and a control unit 13. The input unit 2 is an input device that receives an input from a maker. Here, the maker includes the above “creator” and “reproducer”. The output unit 3 is, for example, a display device. The output unit 3 may also serve as the input unit 2. The above touch panel 21 corresponds to an example in which the output unit 3 also serves as the input unit 2.

The communication unit 11 is achieved by, for example, a network interface card (NIC). The communication unit 11 is connected to the tactile-sense presentation device 100 wiredly or wirelessly, and transmits and receives information to and from the tactile-sense presentation device 100.

The storage unit 12 is achieved by, for example, a semiconductor memory element such as a random access memory (RAM) or a flash memory, or a storage device such as a hard disk or an optical disk. In the example of FIG. 2, the storage unit 12 stores GUI-component information 12a, parameter-related information 12b, design information 12c, and control-signal information 12d.

The GUI-component information 12a is information regarding various GUI components arranged on a tactile-sensation design screen. The parameter-related information 12b is information regarding the above parameters, and includes, for example, identification information of each parameter.

The design information 12c stores the detail of the design in tactile sensation designed by the maker. The control-signal information 12d stores a control signal for the tactile-sense presentation device 100 generated on the basis of the design information 12c.

The control unit 13 is a controller, and is achieved by, for example, a central processing unit (CPU), a micro processing unit (MPU), or the like executing various programs stored in a storage device such as a read only memory (ROM) inside the generation device 10 using the RAM as a work area. Further, the control unit 13 may be achieved by an integrated circuit such as an application specific integrated circuit (ASIC) or a field programmable gate array (FPGA).

The control unit 13 includes a GUI control unit 13a, an acquisition unit 13b, a generation unit 13c, and an output control unit 13d, and achieves or executes the functions and actions of information processing described below.

The GUI control unit 13a performs control processing regarding the GUI for the maker. Specifically, the GUI control unit 13a associates the GUI-component information 12a with the parameter-related information 12b, generates a tactile-sensation design screen with a GUI component arranged, and outputs the tactile-sensation design screen to the output unit 3.

Further, the GUI control unit 13a receives the detail of input that is input from the input unit 2 through the design screen, appropriately updates the design screen in accordance with the detail of the input, and outputs the updated design screen to the output unit 3.

The acquisition unit 13b acquires, from the GUI control unit 13a, the detail of the design in tactile sensation input though the design screen, and stores the detail of the tactile sensation design in the design information 12c.

The generation unit 13c generates a control signal for the tactile-sense presentation device 100 on the basis of the design information 12c, and stores the control signal in the control-signal information 12d.

The output control unit 13d outputs the control signal to the tactile-sense presentation device 100 through the communication unit 11 on the basis of the control-signal information 12d, and causes the tactile-sense presentation device 100 to present a tactile stimulation.

The tactile-sense presentation device 100 includes a communication unit 101, a control unit 102, and a vibration unit 103. Similarly to the above communication unit 11, the communication unit 101 is realized by, for example, an NIC or the like. The communication unit 101 is connected to the generation device 10 wiredly or wirelessly, and transmits and receives information to and from the generation device 10.

Similarly to the above control unit 13, the control unit 102 is a controller, and is achieved by, for example, a CPU, an MPU, or the like executing various programs stored in a ROM or the like inside the tactile-sense presentation device 100 using a RAM as a work area. Further, similarly to the above control unit 13, the control unit 102 can be achieved by, for example, an integrated circuit such as an ASIC or an FPGA.

The control unit 102 causes the vibration unit 103 to drive on the basis of the control signal input through the communication unit 101. Because the vibration unit 103 has already been described, the description thereof will be omitted here.

### 3. EXEMPLARY DESIGNS IN TACTILE SENSATION ACCORDING TO EMBODIMENT

Meanwhile, in the description of the above tactile score, given has been the tactile score that represents identification information and a temporal transition of a parameter resulting from parameterization of a feature that the control signal for the tactile-sense presentation device 100 has as data indicating a tactile sensation.

Therefore, next, specific examples of such parameters and exemplary designs in tactile sensation with the parameters will be described with reference to FIGS. 3A to 3E. FIG. 3A explanatorily illustrates the parameters according to the embodiment. FIG. 3B illustrates an exemplary first design. FIG. 3C illustrates an exemplary second design. FIGS. 3D and 3E illustrates other exemplary designs (part 1) and (part 2), respectively.

[3-1. Exemplary First Design]

In parameterization of a feature that a control signal for the tactile-sense presentation device 100 has as data indicating a tactile sensation, the feature can be parameterized into components such as “strength”, “roughness”, and “pitch” as illustrated in FIG. 3A.

Here, the “strength” is a parameter indicating strength in tactile stimulation to be presented. It may be paraphrased as a parameter expressing the magnitude of output.

The “roughness” is a parameter indicating a state where the same signal does not continue. In terms of vibration, as the “roughness” is larger, the various frequency components are included, and eventually, a state like white noise is obtained. In terms of temperature, a state like a temperature varies quickly to various temperatures such as 20° C. to 10° C. or 10° C. to 30° C.

The “pitch” is a parameter indicating that as the level increase, vibration frequency increases or temperature increases.

FIG. 3A illustrates the waveforms of control signals for four types of combinations in which each of the “strength”, “roughness”, and “pitch” is varied. Regarding the design in tactile sensation, it can be said that the parameterization of the “strength”, “roughness”, and “pitch” is based on an approach from the physical property value that such a control signal has.

As illustrated in FIG. 3B, for example, input of each of these “strength”, “roughness”, and “pitch” used as identification information into a tactile score enables achievement of a visual design in tactile sensation in audio content.

[3-2. Exemplary Second Design]

In the parameterization of the feature that the control signal for the tactile-sense presentation device 100 has as the data indicating the tactile sensation, the feature can be parameterized into components such as “intensity”, “lightness”, “sharpness”, and “comfort” as illustrated in FIG. 3C. Such parameterization indicates how the user who perceives the tactile sensation feels, and it can be said that the parameterization is based on an approach from a sensibility value unlike the above physical property value.

Here, the “intensity” is a parameter indicating that as the level increases, intensity to be felt increases. For example, this corresponds to that the above “strength” is temporally quick and varies by a large amount of variation.

The “lightness” is a parameter indicating that as the level increases, lightness to be felt increases. For example, as frequency is higher, a heavier impression can be smaller, namely, lightness can increase.

The “sharpness” is a parameter indicating that as the level increases, sharpness to be felt increases. For example, sharpness to be felt can increase by instantaneously strong output of a tactile stimulation only at the output start or by shortening of the duration.

The “comfort” is a parameter indicating that as the level increases, comfort to be felt increases. For example, comfort to be felt can increase by reduction of the frequency components that are mixed.

As illustrated in FIG. 3C, for example, input of each of these “intensity”, “lightness”, “sharpness”, and “comfort” used as identification information into a tactile score also enables achievement of a visual design in tactile sensation in audio content.

Note that because the example illustrated in FIG. 3C is the parameterization based on the sensibility value of the user who perceives the tactile sensation, various expressions such as “delight”, “moist”, and “softness” can be used in addition.

[3-3. Exemplary Other Designs]

As a “belly part” and a “wrist part” illustrated in FIGS. 3D and 3E, a tactile score may be designated so as to include a body part to which a tactile sensation is to be given as identification information of the tactile sensation. Furthermore, as illustrated in FIG. 3D, identification information of the tactile sensation such as a data ID may be designated, for example, in the beginning portion or the like of each tactile score (see a portion surrounded by a closed curve of a broken line in the figure).

The data ID is, for example, identification information of each data in a data library in which a predetermined tactile-sensation data group is registered in advance. Such a data library may be included in the generation device 10 or may be included in the tactile-sense presentation device 100. Alternatively, a dedicated device, a cloud server, or the like capable of network communication may include such the data library.

Alternatively, as illustrated in FIG. 3E, a vibration controller that is a device for manipulating the tactile-sense presentation device 100 is provided, and for example, the shape of an operation button of the vibration controller or a mark drawn on the operation button may be designated in the opening portion or the like of the tactile score (see a portion surrounded by a closed curve of a broken line in the figure).

This arrangement enables a visual design in tactile sensation to be shared more easily.

Note that the exemplary designs in tactile sensation described so far are to share a design between the “creator” and the “reproducer” of the tactile sensation mainly in the audio content. However, as described above, instead of the waveform itself or a specific temperature value of a control signal for the tactile-sense presentation device 100, a feature that the control signal has as data indicating the tactile sensation is parameterized, and visually and chronologically represented in a shareable manner.

Thus, it can be said that such a design simply indicates the orientation in reproduction by the reproducer rather than complete reproduction of the creator's intention. Therefore, in a case where the reproducer demonstrates the tactile sensation, obtained can be a result that at least the creator's intention is not greatly impaired although variations and arrangement by the reproducer are included easily.

In addition, the above parameterization, that is, encoding can contribute to a reduction in the amount of time-series information.

### 4. EXEMPLARY DESIGNS IN TACTILE SENSATION ACCORDING TO MODIFICATIONS

Meanwhile, the exemplary designs in tactile sensation in making of audio content including tactile-sensation presentation has been mainly described so far. The generation method according to the embodiment is also applicable to making of video content including tactile-sense presentation.

Therefore, next, as modifications, exemplary designs in tactile sensation in making of video content will be described with reference to FIGS. 4A to 4C. FIG. 4A illustrates a first modification. FIG. 4B illustrates a second modification. FIG. 4C illustrates a third modification.

[4-1. First Modification]

First, FIG. 4A illustrates a design screen in making of video content. The design screen is displayed on, for example, a touch panel 21. The design screen includes a design area DR, body-part objects (OBJ) O1 to O3, effect objects O4 to O7, a save button B1, and a generation button B2.

In the design area DR, for example, a picture continuity of the video content can be input. The picture continuity may be directly input into the design area DR with the above electronic pen P or the like, or created picture-continuity data may be read and developed in the design area DR in an editable manner.

In the design area DR, a “tactile-sense effect” field into which a design in tactile sensation can be input is provided together with a picture-continuity field. For example, the body-part objects O1 to O3 and the effect objects O4 to O7 are dragged-and-dropped and combined in a section of the “tactile-sense effect”, so that a tactile sensation to be expressed can be designed in the “tactile-sense effect” field.

For example, the combination of the body-part object O1 and the effect object O4 enables a design in tactile sensation that moves from the abdomen to the periphery in a best-type tactile-sense presentation device 100.

In addition, as illustrated in an M1 portion in the figure, an onomatopoeia representing the tactile sensation with characters can be input with a keyboard or the like. Furthermore, the strength of the tactile sensation can be expressed with the size of the characters. In the example of the M1 portion, designed can be a strongly-tingling tactile sensation that moves from the abdomen to the periphery in the best-type tactile-sense presentation device 100.

For example, the effect object O5 indicating the duration is dragged-and-dropped into a section of the “tactile-sense effect” field and the length of the effect object O5 is adjusted, so that the duration of the tactile sensation can be also designed (see an arrow 401 in the figure).

As illustrated in an M2 portion in the figure, for example, the effect object O6 indicating intensity in tactile sensation is dragged-and dropped into a section of the “tactile-sense effect” field and the size of the effect object O6 is changed, so that the degree of the intensity in tactile sensation can also be represented.

As illustrated in an M3 portion in the figures for example, the effect object O7 indicating a temporal transition in tactile sensation is dragged-and-dropped into a section of the “tactile-sense effect” field and the waveform indicating the temporal transition is changed, so that, for example, a variation in strength in tactile sensation can also be designated freely.

In addition, for example, the save button B1 is operated by touch, so that the detail of the current design can be stored into design information 12c. Note that, in the design information 12c, the detail of a design correlated to each parameter of a tactile sensation corresponding to the object or the onomatopoeia designated in corresponding section of the “tactile-sense effect” field is stored.

Furthermore, the generation button B2 is operated by touch, so that a control signal for the tactile-sense presentation device 100 is generated on the basis of the detail of the design stored in the design information 12c and the control signal is stored in control-signal information 12d.

In such a manner, in making of video content, a tactile sensation can be visually and intuitively designed with such a design screen as illustrated in FIG. 4A, so that the tactile sensation to be expressed can be designed easily. Further, the tactile sensation to be expressed can be shared in a manner different from any manners based on actually physical experience among the makers.

[4-2. Second Modification]

Next, FIG. 4B illustrates a design screen different from that in FIG. 4A. The design screen illustrated in FIG. 4B includes a video reproduction area MR. Further, the design screen includes an effect object O8 and a range designation button B3.

The video reproduction area MR includes, for example, a seek bar SB, a reproduction operation button MB, and a design area DR.

In the video reproduction area MR, for example, a picture continuity of video content is displayed so as to be reproducible in a moving-image format. Note that the picture continuity may be reproducible on a frame basis in a slide-show format. The video is not limited to the picture continuity, and may be a video (V) continuity. Further, the video is not limited to a continuity, and may be normal video.

The reproduction position can be freely designated by operation of the seek bar SB with a pointing device such as a mouse. Furthermore, for example, reproduction or pause at any position can be performed with the reproduction operation button MB.

In the design area DR, a range on the time axis for designing a tactile sensation can be designated. Such range can be designated, for example, with a pointing device such as a mouse in a range designation mode after the range designation button B3 is operated by touch. Note that FIG. 4B illustrates an example in which ranges R1, R2, and R3 are designated.

Similarly to the sections of the “tactile-sense effect” illustrated in FIG. 4A, in each of the designated ranges R1, R2, and R3, for example, a body-part object and an effect object is dragged-and-dropped and combined or an onomatopoeia is input, so that a tactile sensation to be expressed can be designed.

Note that FIG. 4A illustrates an example in which the tactile sensation is input as the onomatopoeia referred to as “tingling . . . ” and FIG. 4B illustrates an example in which the tactile sensation corresponding to the “tingling . . . ” is designated in the range R1 by the effect object O8 (see a portion M4 in the figure).

Such an onomatopoeia, effect object, and a tactile sensation indicated by these onomatopoeia and effect object are associated between GUI-component information 12a and parameter-related information 12b.

In such a manner, in making of video content, a tactile sensation can be visually and intuitively designed with such a design screen as illustrated in FIG. 4B, so that the tactile sensation to be expressed can be designed easily. Further, the tactile sensation to be expressed can be shared in a manner different from any manners based on actually physical experience among the makers.

[4-3. Third Modification]

Note that, on a design screen, as illustrated in FIG. 4C, for example, words regarding a design in tactile sensation may be able to be input into video, like a subtitle. In such a manner, words regarding a design in tactile sensation are directly correlated to video, so that a tactile sensation to be expressed can be easily shared in a manner different from any manners based on actually physical experience among the makers. That is, the design in tactile sensation can be shared even in a situation where a tactile-sense presentation device 100 is not provided and the tactile sensation is hard to be experienced physically.

In addition, design information 12c in which the detail of a design is stored may be output in a browsable format, for example, as electronic data, and may be distributable. In such a case, for example, when a mouse pointer is moved to a section of a “tactile-sense effect” at the time of browsing on the distributed side, the mouse pointer may waver in accordance with the detail of the design, so that the designed detail can be expressed.

### 5. PROCESSING PROCEDURE OF GENERATION SYSTEM ACCORDING TO EMBODIMENT

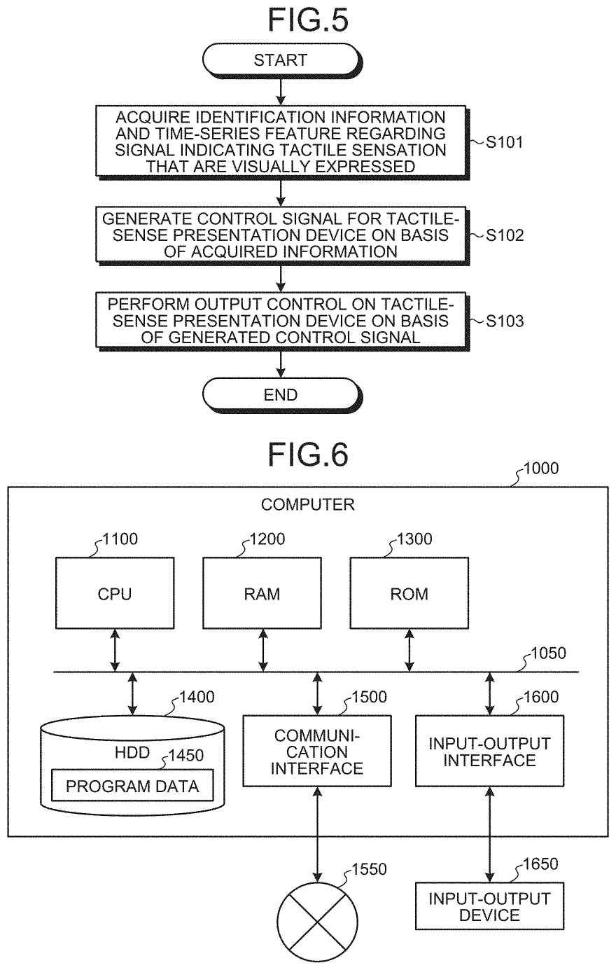

Next, a processing procedure executed by the generation system 1 according to the embodiment will be described with reference to FIG. 5. FIG. 5 is a flowchart illustrating a processing procedure executed by the generation system 1 according to the embodiment.

As illustrated in FIG. 5, first, the acquisition unit 13b acquires identification information and a time-series feature regarding a signal indicating a tactile sensation that are visually expressed (Step S101).

Then, the generation unit 13c generates a control signal for the tactile-sense presentation device 100 on the basis of the acquired information (namely, the identification information and the time-series feature) (Step S102).

Then, the output control unit 13d performs output control on the tactile-sense presentation device 100 on the basis of the generated control signal (Step S103), and the processing ends.

### 6. HARDWARE CONFIGURATION

The information device such as the generation device 10 or the tactile-sense presentation device 100 according to the above embodiment is achieved by, for example, a computer 1000 having such a configuration as illustrated in FIG. 6. Hereinafter, the generation device 10 according to the embodiment will be described as an example. FIG. 6 is a hardware configuration diagram illustrating an example of the computer 1000 that achieves the functions of the generation device 10. The computer 1000 includes a CPU 1100, a RAM 1200, a ROM 1300, a hard disk drive (HDD) 1400, a communication interface 1500, and input-output interface 1600. Each constituent of the computer 1000 is connected by a bus 1050.

The CPU 1100 operates in accordance with a program stored in the ROM 1300 or the HDD 1400, and controls each constituent. For example, the CPU 1100 expands the program stored in the ROM 1300 or the HDD 1400 into the RAM 1200, and executes processing in accordance with the corresponding program.

The ROM 1300 stores a boot program such as a basic input output system (BIOS) executed by the CPU 1100 on startup of the computer 1000, a program dependent on the hardware of the computer 1000, and the like.

The HDD 1400 is a computer-readable recording medium that non-temporarily stores a program executed by the CPU 1100, data used by the program, and the like. Specifically, the HDD 1400 is a recording medium that stores the generation processing program according to the present disclosure that is an example of program data 1450.

The communication interface 1500 is an interface for connecting the computer 1000 and an external network 1550 (for example, the Internet). For example, the CPU 1100 receives data from another device or transmits data generated by the CPU 1100 to the other device through the communication interface 1500.

The input-output interface 1600 is an interface for connecting an input-output device 1650 and the computer 1000. For example, the CPU 1100 receives data from an input device such as a keyboard or a mouse through the input-output interface 1600. Further, the CPU 1100 transmits data to an output device such as a display, a speaker, or a printer through the input-output interface 1600. The input-output interface 1600 may function as a media interface that reads a program or the like stored in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in the case where the computer 1000 functions as the generation device 10 according to the embodiment, the CPU 1100 of the computer 1000 executes the generation processing program loaded on the RAM 1200 to achieve the functions of, for example, the acquisition unit 13b and the generation unit 13c. The HDD 1400 stores the generation processing program according to the present disclosure and data in the storage unit 12. Note that the CPU 1100 reads the program data 1450 from the HDD 1400 and executes the program data 1450; however, as another example, these programs may be acquired from another device through the external network 1550.

### 7. CONCLUSION

As described above, according to the embodiment of the present disclosure, provided is a generation device capable of generating a control signal for tactile-sense presentation while sharing a tactile sensation to be expressed in a manner different from any manners based on actually physical experience.

Note that, of the pieces of processing described in the above embodiment, the entirety or part of the processing that has been described as being automatically performed can be performed manually, or the entirety or part of the processing that has been described as being performed manually can be performed automatically with a known method. In addition to the above, the processing procedures, specific names, information including various types of data and parameters given in the above description and drawings can be freely changed unless otherwise specified. For example, the various types of information illustrated in each figure are not limited to the given information.

Furthermore, each constituent element of the illustrated devices is functionally conceptual, and thus is not necessarily configured physically as illustrated. Namely, the specific mode of separation or integration of each device is not limited to that illustrated in the figures, and thus the entirety or part of each device can be functionally or physically separated or integrated on arbitrary unit basis in accordance with various types of loads or usage situations.

For example, the GUI control unit 13a and the acquisition unit 13b illustrated in FIG. 2 may be integrated. Furthermore, for example, the information stored in the storage unit 12 may be stored in a predetermined storage device provided outside, through a network.

In the above embodiment, the example has been described in which the generation device 10 performs, for example, the acquisition processing of acquiring identification information and a time-series feature regarding a signal indicating a tactile sensation that are visually expressed; the generation processing of generating a control signal for a tactile-sense presentation device 100, on the basis of the identification information and the time-series feature acquired by the acquisition processing; and the output-control processing of performing output control on the tactile-sense presentation device 100, on the basis of the control signal generated by the generation processing. However, the above generation device 10 may be provided as an acquisition device that performs the acquisition processing, a generation device that performs the generation processing, and an output control device that performs the output-control processing that are provided separately. In this case, the acquisition device includes at least the acquisition unit 13b. The generation device includes at least the generation unit 13c. The output control device includes at least the output control unit 13d. The above processing by the generation device 10 is achieved by the generation system 1 including the devices that are the acquisition device, the generation device, and the output control device.

Furthermore, in the above embodiment, the example has been described in which the tactile-sense presentation device 100 is subjected to the output control based on the control signal generated by the generation device 10. However, the tactile-sense presentation device 100 may acquire identification information and a time-series feature regarding a signal indicating a tactile sensation input to the generation device 10 in a visual expression, generate a control signal for presenting the tactile sense on the basis of the identification information and the time-series feature, and present the tactile sense on the basis of the control signal. In this case, the generation device 10 functions as an input device including at least the GUI control unit 13a.

Still furthermore, in the above embodiment, the example in which the generation device 10 and the tactile-sense presentation device 100 are provided separately has been described. However, the generation device 10 and the tactile-sense presentation device 100 may be integrally provided in, for example, a smartphone or the like. In this case, the smartphone itself serves as the tactile-sense presentation device 100, and each function executed by the GUI control unit 13a, the acquisition unit 13b, the generation unit 13c, and the output control unit 13d of the generation device 10 is achieved as each function of the application that operates on the smartphone.

Note that in a case where the generation device 10 and the tactile-sense presentation device 100 are integrally mounted on the smartphone as described above, the generation system 1 according to the embodiment is applicable to, for example, a moving-image sharing service in a social networking service (SNS). In this case, the owner of the smartphone is the maker (creator who designs a tactile sensation and reproducer who reproduces the design), and the tactile stimulation is presented to the viewer of content made by the maker.

The above embodiment and modifications can be appropriately combined within the range in which the detail of processing is not inconsistent.

The preferred embodiment of the present disclosure has been described above in detail with reference to the accompanying drawings; however, the present technology of the present disclosure is not limited to the examples. It is obvious that a person having ordinary knowledge in the technical field of the present disclosure may conceive various types of changes or modifications within the scope of the technical idea described in the claims, and thus it should be understood that the various types of changes or modifications also belong to the technical scope of the present disclosure.

(Effects)

As described above, the generation device 10 according to the embodiment of the present disclosure includes the acquisition unit 13b and the generation unit 13c. The acquisition unit 13b acquires identification information and a time-series feature regarding a signal indicating a tactile sensation that are visually expressed. The generation unit 13c generates a control signal for the tactile-sense presentation device 100 on the basis of the above identification information and the above time-series feature acquired by the acquisition unit 13b.

This arrangement enables the generation device 10 to generate a control signal for tactile-sense presentation while sharing a tactile sensation to be expressed in a manner different from any manners based on actually physical experience.

The generation device 10 further includes the output control unit 13d. The output control unit 13d performs output control on the tactile-sense presentation device 100 on the basis of the control signal generated by the generation unit 13c.

This arrangement enables the generation device 10 to cause the tactile-sense presentation device 100 to present a tactile stimulation on the basis of a control signal generated while sharing the tactile sensation to be expressed in a manner different from any manners based on actual physical experience.

The above identification information includes a parameter obtained by encoding of a feature included in the above signal indicating a tactile sensation, and the above time-series feature indicates a temporal transition of the above parameter.

Thus, with the generation device 10, a tactile sensation can be designed without at least the creator's intention not impaired while reducing the amount of time-series information by the encoding.

The above parameter is extracted on the basis of a physical property value and a sensibility value indicated by the above signal.

Thus, with the generation device 10, various tactile sensations can be designed in accordance with the physical property value and the sensibility value of the above signal.

In making of audio content, the generation unit 13c generates the above control signal on the basis of the above identification information and the above time-series feature expressed with a tactile score in which the above temporal transition for each piece of the above identification information is notated with a curve.

Thus, with the generation device 10, a tactile sensation with the detail suitable for the making of audio content can be designed and a control signal for the tactile-sense presentation device 100 can be generated on the basis of the design.

In making of video content, the generation unit 13c generates the above control signal on the basis of the above identification information and the above time-series feature expressed with a character (for example, onomatopoeia) that is input in any designated range and indicates a predetermined tactile sensation or expressed with an object associated with the predetermined tactile sensation.

Thus, with the generation device 10, a tactile sensation with the detail suitable for making of video content can be designed and a control signal for the tactile-sense presentation device 100 can be generated on the basis of the design.

The tactile-sense presentation device 100 according to the embodiment of the present disclosure includes the vibration unit 103 and the control unit 102. The control unit 102 acquires identification information and a time-series feature regarding a signal indicating a tactile sensation that are visually expressed, and generates a control signal for vibrating the vibration unit 103 on the basis of the above identification information and the above time-series feature that are acquired.

This arrangement enables the tactile-sense presentation device 100 to generate a control signal for tactile-sense presentation while sharing a tactile sensation to be expressed in a manner different from any manners based on actually physical experience.

Note that the effects described herein are merely explanatory or exemplary, and thus are not limiting. Namely, the technology according to the present disclosure may exhibit other effects apparent to those skilled in the art from the description herein, in addition to or in place of the above effects.

Note that the present technology can also adopt the configurations below.

(1)

A generation device, comprising:

an acquisition unit configured to acquire identification information and a time-series feature regarding a signal indicating a tactile sensation, the identification information and the time-series feature being visually expressed; and

a generation unit configured to generate a control signal for a tactile-sense presentation device, on a basis of the identification information and the time-series feature acquired by the acquisition unit.

(2)

The generation device according to (1), further comprising:

an output control unit configured to perform output control on the tactile-sense presentation device, on a basis of the control signal generated by the generation unit.

(3) The generation device according to (1) or (2),

wherein the identification information

includes a parameter obtained by encoding of a feature included in the signal indicating the tactile sensation, and

the time-series feature

indicates a temporal transition of the parameter.

(4)

The generation device according to (3),

wherein the parameter is

extracted on a basis of a physical property value and a sensibility value indicated by the signal.

(5)

The generation device according to (3) or (4),

wherein, in making of audio content, the generation unit

generates the control signal, on a basis of the identification information and the time-series feature expressed with a tactile score in which the temporal transition for each piece of the identification information is notated with a curve.

(6)

The generation device according to any one of (3) to (5),

wherein, in making of video content, the generation unit

generates the control signal, on a basis of the identification information and the time-series feature expressed with a character that is input in any designated range and indicates a predetermined tactile sensation or expressed with an object associated with the predetermined tactile sensation.

(7)

A generation method executed by a computer, the generation method comprising:

acquiring identification information and a time-series feature regarding a signal indicating a tactile sensation, the identification information and the time-series feature being visually expressed; and

generating a control signal for a tactile-sense presentation device, on a basis of the identification information and the time-series feature acquired by the acquiring.

(8)

A program for causing a computer to execute:

an acquisition procedure of acquiring identification information and a time-series feature regarding a signal indicating a tactile sensation, the identification information and the time-series feature being visually expressed; and

a generation procedure of generating a control signal for a tactile-sense presentation device, on a basis of the identification information and the time-series feature acquired by the acquisition procedure.

(9)

A tactile-sense presentation device comprising:

a vibration unit; and a control unit,

wherein the control unit

acquires identification information and a time-series feature regarding a signal indicating a tactile sensation that are visually expressed, and generates a control signal for vibrating the vibration unit, on a basis of the identification information and the time-series feature that are acquired.

### REFERENCE SIGNS LIST

1 GENERATION SYSTEM
10 GENERATION DEVICE
11 COMMUNICATION UNIT
12 STORAGE UNIT
13 CONTROL UNIT
13a GUI CONTROL UNIT
13b ACQUISITION UNIT
13c GENERATION UNIT
13d OUTPUT CONTROL UNIT
100 TACTILE-SENSE PRESENTATION DEVICE
101 COMMUNICATION UNIT
102 CONTROL UNIT
103 VIBRATION UNIT

1. A generation device, comprising:
an acquisition unit configured to acquire identification information and a time-series feature regarding a signal indicating a tactile sensation, the identification information and the time-series feature being visually expressed; and
a generation unit configured to generate a control signal for a tactile-sense presentation device, on a basis of the identification information and the time-series feature acquired by the acquisition unit.

2. The generation device according to claim 1, further comprising:
an output control unit configured to perform output control on the tactile-sense presentation device, on a basis of the control signal generated by the generation unit.

3. The generation device according to claim 1,
wherein the identification information
includes a parameter obtained by encoding of a feature included in the signal indicating the tactile sensation, and
the time-series feature
indicates a temporal transition of the parameter.

4. The generation device according to claim 3,
wherein the parameter is
extracted on a basis of a physical property value and a sensibility value indicated by the signal.

5. The generation device according to claim 3,
wherein, in making of audio content, the generation unit
generates the control signal, on a basis of the identification information and the time-series feature expressed with a tactile score in which the temporal transition for each piece of the identification information is notated with a curve.

6. The generation device according to claim 3,
wherein, in making of video content, the generation unit
generates the control signal, on a basis of the identification information and the time-series feature expressed with a character that is input in any designated range and indicates a predetermined tactile sensation or expressed with an object associated with the predetermined tactile sensation.

7. A generation method executed by a computer, the generation method comprising:
acquiring identification information and a time-series feature regarding a signal indicating a tactile sensation, the identification information and the time-series feature being visually expressed; and
generating a control signal for a tactile-sense presentation device, on a basis of the identification information and the time-series feature acquired by the acquiring.

8. A program for causing a computer to execute:
an acquisition procedure of acquiring identification information and a time-series feature regarding a signal indicating a tactile sensation, the identification information and the time-series feature being visually expressed; and
a generation procedure of generating a control signal for a tactile-sense presentation device, on a basis of the identification information and the time-series feature acquired by the acquisition procedure.

9. A tactile-sense presentation device comprising:
a vibration unit; and a control unit,
wherein the control unit
acquires identification information and a time-series feature regarding a signal indicating a tactile sensation that are visually expressed, and generates a control signal for vibrating the vibration unit, on a basis of the identification information and the time-series feature that are acquired.
